(19) United States
(12) Patent Application Publication
(10) Pub. No.: US 2004/0026659 A1
(43) Pub. Date: Feb. 12, 2004

(54) Composition for fabricating phase-change-material microcapsules and a method for fabricating the microcapsules

(75) Inventor: Yen-Hsi Lin, Wen Shan Dist (TW)

Correspondence Address: BAKER & HOSTETLER LLP, Washington Square, Suite 1100, 1050 Connecticut Avenue, N.W., WASHINGTON, DC, 20036, US

(73) Assignee: China Textile Institute

(21) Appl. No.: 10/612,994

(22) Filed: Jul. 7, 2003

(30) Foreign Application Priority Data
Jul. 8, 2002 (TW) 91115039
Jul. 8, 2002 (TW) 91115109

(51) Int. Cl. B01J 13/02

(52) U.S. Cl. 252/183.11; 264/4.7

(57) ABSTRACT

A composition for fabricating phase-change-material microcapsule and a method for fabricating microcapsule are provided. The composition at least includes 5% to 40% weight percentage of waterborne polyurethane aqueous solution, phase change material, monomer and solid wax. The lipophilic monomer solves in the phase change material and the weight percentage is between about 3% and 12% and the weight ratio of lipophilic monomer to waterborne polyurethane is between about 25% and 50%. The composition is emulsified by stirring and several stages heating process is performed to fabricate the microcapsules.

### BACKGROUND OF THE INVENTION

1. Field of Invention

The present invention relates to a composition for fabricating phase-change-material microcapsules and a method for fabricating the microcapsules. More particularly, the present invention relates to fabricate phase-change-material microcapsules, which is used for fabric.

2. Description of Related Art

Heat storage (release) materials, namely phase-change materials (PCMS), undergoes physical phase changes, e.g. solid phase to liquid phase or liquid phase to solid phase, in a specific temperature range. Indeed, many materials can be regarded as PCMS in a particular temperature range. For example, in the temperature range of about 0° C., water-ice can be used as PCMS.

Two factors need to be considered for choosing PCMS, including the temperature range that PCMS is applicable and the amount (size) of latent heat absorbed or released by PCMS during the phase change. Basically, PCMS having the proper temperature range is selected based on the environmental temperature requirements. Preferably, PCMS with larger latent heat changes are used. Since larger latent heat changes allow more heat being absorbed/released during the phase change, PCMS can stay in the phase-change temperature range for a longer period.

During the heating process, the temperature of PCMS keeps rising until the melting point is reached. During the phase changing process, the temperatures of PCMS and the surrounding environment stay constant until the phase changing process is completed. If PCMS is further heated, the temperature of PCMS will go up.

If PCMS is cooled down to the phase-change crystallization temperature, latent heat will be released. As PCMS changes from liquid phase to solid phase, the temperature of PCMS keeps constant until the phase changing process is completed. After that, the temperature of PCMS keeps decreasing if it is further cooled down.

In general, PCMS changes between liquid phase and solid phase in real applications. PCMS needs to be wrapped by a covering layer to prevent loss, especially PCMS in liquid phase. Therefore, a recent technology has been developed to wrap PCMS with microcapsules, in order not to lose liquid-phase PCMS.

A method for fabricating the microcapsules comprises a chemical synthetic method, a physical chemical synthetic method and a physical mechanical synthetic method. The chemical synthetic method comprises interfacial condensation polymerization method, in-situ polymerization method and shape-hole condensed bath method. The interfacial condensation polymerization method has several advantages, such as fast reaction rate, mild reaction condition, loose requirement of the purity of the starting material, and high tolerance of ratio of the starting material in the composition. Therefore, interests in the field are always preferred to use interfacial condensation polymerization method. Typically, material of shells of the microcapsules is polymer.

An oil phase and a water phase are used in the interfacial condensation polymerization method. A solvent used in the water phase is water and a solvent used in the oil phase comprises dichloromethane, chloroform, trichloroethane, tetrachlorodifluoroethane, carbon tetrachloride, benzene, toluene, xylene, carbon disulfide, pentane, cyclohexane, mineral oil and a combination thereof. The phase-change-material and a lipophilic monomer for forming the shell of the microcapsule are solved in the oil phase. At least one hydrophilic monomer for forming the shell of the microcapsule is solved in the water phase. Additionally, a surfactant is included in the water phase.

The surfactant is a very important in the interfacial condensation polymerization method. Micelles are formed by the surfactant surrounding the oil phase and are brought into the water phase through the surfactant. A polymerization reaction occurs on the interface of the micelles. The shell of the microcapsule is formed by the polymerization of the lipophilic monomer and the hydrophilic monomer on the interface of the micelle. The shell encloses the phase-change-material solved in the micelle and the phase-change-material microcapsule is formed. The surfactant used in the interfacial condensation polymerization method comprises polyethylene alcohol, glutin, methyl cellulose or other surfactants.

Typically, the phase-change-material used in the prior interfacial condensation polymerization method is non-polar or low polarity compound, such as alkyl alkane or aryl alkane. The phase-change-material and the lipophilic monomer are hard to become a homogeneous phase, because the lipophilic monomer, such as phenylethene, isocyanate salt, is a polar or high polarity compound. Therefore, at least one organic solvent has to be added in the oil phase to form a homogeneous oil phase.

The disadvantage of using organic solvent is, the organic solvent could be remained inside the microcapsule. The remained organic solvent inside the microcapsule affects the thermal property of the microcapsule and the designed phase change temperature range altered. In prior interfacial condensation polymerization method for fabricating the microcapsule, a heating process is used to remove the organic solvent but there is still residue left inside the microcapsule. Additionally, the fabricated microcapsules by prior interfacial condensation polymerization method are dispersed in organic solvent because the lipophilic shell. The fabric coating solution with microcapsules suspended inside is aqueous solution, therefore the organic solvent has to be removed. In the solvent removing process, high temperature could damage the polymer shell of the microcapsule. This detriment causes the microcapsule breaking in latter processes and the phase-change-material escapes.

### SUMMARY OF THE INVENTION

From the analyses of the disadvantage of the prior interfacial condensation polymerization method, it is very clear that the key point of solving these problems is at the organic solvent. If a new interfacial condensation polymerization method without using organic solvent is provided, all problems described above are solved. If removing the organic solvent from the prior interfacial condensation polymerization method only, the method cannot work anymore because the lipophilic monomer can't be solved in the phase-change-material.

It is therefore an objective of the present invention to provide a composition used in an interfacial condensation polymerization method for fabricating phase-change-material microcapsules, in which the organic solvent is not necessary.

It is another an objective of the present invention to provide a composition used in an interfacial condensation polymerization method for fabricating phase-change-material microcapsules, in which microcapsules with hydrophilic shell are fabricated and the microcapsules are dispersed in water phase.

It is still another an objective of the present invention to provide a composition used in an interfacial condensation polymerization method for fabricating phase-change-material microcapsules, in which a polar phase-change-material is used as oil phase to solve the lipophilic monomer, therefore the organic solvent could be excluded from this composition.

It is still the fourth objective of the present invention to provide a composition used in an interfacial condensation polymerization method for fabricating phase-change-material microcapsules, in which the surfactant is not necessary in the composition.

In accordance with the foregoing and other objectives of the present invention, a composition used in interfacial condensation polymerization method for fabricating phase-change-material microcapsules comprises two different phases, water phase and oil phase. The solvent in the water phase is water, in which at least comprises waterborne polyurethane, the waterborne polyurethane is selected from a group consisting waterborne polyurethane, 2,2-bis (hydroxymethyl) propionic acid triethylamine salt, diamine containing sulfonate salt and a combination thereof. A weight percentage concentration of waterborne polyurethane in the water phase is 5% to 40%. A preferred weight percentage concentration of waterborne polyurethane aqueous solution is between about 15% and 35%.

The oil phase at least comprises phase-change-material, lipophilic monomer and solid wax. The phase-change-material is an organic compound with polarity, such as carboxylic ester. The carboxylic ester with higher polarity than hydrocarbon compound can solves more lipophilic monomer. A carboxylate of the carboxylic ester is selected from a group formate, acetate and propionate and carbon numbers of an alkoxyl of the carboxylic ester is between 10 and 18. The phase change temperature of the carboxylic ester is between about minus 20 degree Celsius and 40 degree Celsius. Understandably, longer alkoxyl chain is adapted to be used at higher temperature, such as, the carboxylic ester with 20 carbons to 28 carbons alkoxyl group is adapted to be used between about 45 degree Celsius and 80 degree Celsius.

The lipophilic monomer and the waterbone polyurethane polymerize to form the shell of the microcapsules in the interfacial condensation polymerization process. The lipophilic monomer is melamine or isocyanate salt. The lipophilic monomer solves in the phase change material and the weight percentage is between about 3% and 12%, and preferred weight percentage of the lipophilic monomer basing on the phase change material is between about 5% and 10%. In the meanwhile, the weight ration of lipophilic monomer and waterborne polyurethane is between about 25% and 50%, and preferred weight ration is between about 30% and 45%. The phase-change-material and the solid wax are covered by hydrophilic shell and the microcapsules are fabricated. The melting point of the solid wax is very high, the phase of the solid wax dose not change in an operation temperature range of the microcapsules, therefore, the solid wax is used as seed when the phase-change-material changes from liquid to solid.

The water phase and the oil phase are added in a reactor. A homogenizer, such as a mechanical stir, is used to perform an emulsification process. A stirring speed of the mechanical stir is between about 4000 rpm and 9000 rpm and the stirring process keeps for 2 minutes to 5 minutes. A heating process is performed after the emulsification process finish. The heating process is a kind of at least two stages elevating temperature process, at each stage, the temperature is kept for about 1 hour to 5 hours and the temperature range used in the process is between about 20 degree Celsius and 90 degree Celsius. In the heating process, for example, a first temperature between about 20 degree Celsius and 40 degree Celsius maintaining for about 2 hours to 5 hours is provided first. Secondly, the temperature is elevated to a second temperature, which is between about 40 degree Celsius and 60 degree Celsius. The second temperature is kept for about 1 hours to 3 hours. Then, the temperature is elevated to a third temperature, which is between about 60 degree Celsius and 90 degree Celsius. The third temperature is kept for about 30 minutes to 2 hours. The total time for the heating process is between about 3.5 hours and 10 hours and the microcapsules are formed.

The waterborne polyurethane used in the interfacial condensation polymerization method provided in the present invention is not only a monomer for polymerization process but is used as a surfactant. Micelles are formed by the waterborne polyurethane surrounding the oil phase and are brought into the water phase through the waterborne polyurethane. A polymerization reaction occurs on the interface of the micelles. The shell of the microcapsule is formed by the polymerization of the waterborne polyurethane and the hydrophilic monomer on the interface of the micelle. The shell encloses the phase-change-material solved in the micelle and the phase-change-material microcapsule is formed and the phase-change-material microcapsule is formed. Therefore, the surfactant in the interfacial condensation polymerization method provided in the present invention is not necessary.

Although the organic solvent can be excluded in the interfacial condensation polymerization method provided in the present invention, but organic solvent still can be used in the method because the microcapsules with hydrophilic shell disperse in the water phase. The residual organic solvent can be separated from the water phase by distilling under reduced pressure. In the composition with organic solvent of the present invention, the surfactant is still not necessary.

These and other features, aspects, and advantages of the present invention will become better understood with reference to the following description and appended claims.

It is to be understood that both the foregoing general description and the following detailed description are by examples, and are intended to provide further explanation of the invention as claimed.

### DESCRIPTION OF THE PREFERRED EMBODIMENTS

The composition for fabricating phase-change-material microcapsules and a method for fabricating the microcapsules of the present invention can be more fully understood by reading the following detailed description of the preferred examples as follows:

### EXAMPLE 1

A composition with waterborne polyurethane 69 grams, water 300 grams, isocyanurate of 1,6-hexamethylene diisocyanate 11 grams, hexadecanyl formate 207 grams and solid wax 11 grams is put in a reactor, in which a water phase comprises waterborne polyurethane and water. The oil phase comprises isocyanurate, hexadecanyl formate and solid wax.

A homogenizer stirs the composition at 7000 rpm for 3 minutes. After the stirring process, the temperature of the composition is elevated to 40 degrees Celsius and the temperature is kept for 1 hour. Thereafter, the temperature of the composition is not elevated at a rate of 10 degrees per hour until the temperature is 90 degrees Celsius. The temperature, 90 degrees Celsius is kept for 1 hour. Finally, natriumdodecylsulfate 7.7 grams, is added to the composition. The natriumdodecylsulfate is a stabilizer and a aqueous solution with 30% solid contained is obtained, in which the particle size of the microcapsules is between about 1 micrometer and 2 micrometer and the phase change temperature is about at 28 degrees Celsius.

### EXAMPLE 2

A composition with waterborne polyurethane 91 grams, water 300 grams, isocyanurate of 1,6-hexamethylene diisocyanate 15 grams, octadecanyl acetate 195 grams and solid wax 10 grams is put in a reactor, in which a water phase comprises waterborne polyurethane and water. The oil phase comprises isocyanurate, octadecanyl acetate and solid wax.

A homogenizer stirs the composition at 6500 rpm for 3 minutes. After the stirring process, the temperature of the composition is elevated to 60 degrees Celsius and the temperature is kept for 3 hour. Thereafter, the temperature of the composition is elevated to 80 degrees Celsius. The temperature, 80 degrees Celsius is kept for 3 hour. Finally, natriumdodecylsulfate 4 grams, is added to the composition. The natriumdodecylsulfate is a stabilizer and a aqueous solution with 40% solid contained is obtained, in which the particle size of the microcapsules are between about 1.5 micrometer and 2.5 micrometer and the phase change temperature is about at 30 degrees Celsius.

### EXAMPLE 3

A composition with waterborne polyurethane 115 grams, water 300 grams, isocyanurate of 1,6-hexamethylene diisocyanate 18 grams, hexadecanyl acetate 182 grams and solid wax 10 grams is put in a reactor, in which a water phase comprises waterborne polyurethane and water. The oil phase comprises isocyanurate, hexadecanyl acetate and solid wax.

A homogenizer stirs the composition at 5000 rpm for 4 minutes. After the stirring process, the temperature of the composition is elevated to 40 degrees Celsius and the temperature is kept for 3 hour. Thereafter, the temperature of the composition is elevated to 60 degrees Celsius and the temperature is kept for 2 hour. The temperature is then elevated to 80 degrees Celsius and the temperature is kept for 1 hour. Finally, natriumdodecylsulfate 6.4 grams, is added to the composition. The natriumdodecylsulfate is a stabilizer and a aqueous solution with 45% solid contained is obtained, in which the particle size of the microcapsules are between about 2 micrometer and 3.5 micrometer and the phase change temperature is about at 24 degrees Celsius.

### EXAMPLE 4

A composition with waterborne polyurethane 83 grams, water 300 grams, isocyanurate of 1,6-hexamethylene diisocyanate 13 grams, octadecanyl acetate 100 grams, hexadecanyl acetate 100 grams and solid wax 10 grams is put in a reactor, in which a water phase comprises waterborne polyurethane and water. The oil phase comprises isocyanurate, octadecanyl acetate, hexadecanyl acetate and solid wax.

A homogenizer stirs the composition at 6000 rpm for 3 minutes. After the stirring process, the temperature of the composition is elevated to 45 degrees Celsius and the temperature is kept for 3 hour. Thereafter, the temperature of the composition is elevated to 65 degrees Celsius and the temperature is kept for 2 hour. The temperature is then elevated to 85 degrees Celsius and the temperature is kept for 1 hour. Finally, natriumdodecylsulfate 6 grams, is added to the composition. The natriumdodecylsulfate is a stabilizer and a aqueous solution with 35% solid contained is obtained, in which the particle size of the microcapsules are between about 1.5 micrometer and 2.5 micrometer and the phase change temperature is about at 28 degrees Celsius.

### EXAMPLE 5

A composition with waterborne polyurethane 124 grams, water 300 grams, isocyanurate of 1,6-hexamethylene diisocyanate 20 grams, octadecanyl acetate 89 grams, octadecanyl propionate 89 grams and solid wax 9 grams is put in a reactor, in which a water phase comprises waterborne polyurethane and water. The oil phase comprises isocyanurate, octadecanyl acetate, octadecanyl propionate and solid wax.

A homogenizer stirs the composition at 7500 rpm for 2.5 minutes. After the stirring process, the temperature of the composition is elevated to 45 degrees Celsius and the temperature is kept for 3 hour. Thereafter, the temperature of the composition is elevated to 60 degrees Celsius and the temperature is kept for 1 hour. Thereafter, the temperature is elevated to 75 degrees Celsius and the temperature is kept for 1 hour. The temperature is then elevated to 90 degrees Celsius and the temperature is kept for 1 hour. Finally, natriumdodecylsulfate 6.4 grams, is added to the composition. The natriumdodecylsulfate is a stabilizer and a aqueous solution with 45% solid contained is obtained, in which the particle size of the microcapsules are between about 0.5 micrometer and 1.5 micrometer and the phase change temperature is about at 29 degrees Celsius.

### EXAMPLE 6

A composition with waterborne polyurethane 110 grams, water 300 grams, isocyanurate of 1,6-hexamethylene diisocyanate 16 grams, octadecanyl propionate 185 grams and solid wax 10 grams is put in a reactor, in which a water phase comprises waterborne polyurethane and water. The oil phase comprises isocyanurate, octadecanyl propionate and solid wax.

A homogenizer stirs the composition at 8000 rpm for 2 minutes. After the stirring process, the temperature of the composition is elevated to 40 degrees Celsius and the temperature is kept for 1 hour. Thereafter, the temperature of the composition is not elevated at a rate of 10 degrees per hour until the temperature is 90 degrees Celsius. The temperature, 90 degrees Celsius is kept for 1 hour. Finally, sorbitan monooleate 3 grams, is added to the composition. The sorbitan monooleate is a stabilizer and a aqueous solution with 45% solid contained is obtained, in which the particle size of the microcapsules are between about 0.5 micrometer and 1.5 micrometer and the phase change temperature is about at 27 degrees Celsius.

### EXAMPLE 7

A composition with waterborne polyurethane 85 grams, water 300 grams, isocyanurate of 1,6-hexamethylene diisocyanate 13 grams, decanyl acetate 200 grams and solid wax 11 grams is put in a reactor, in which a water phase comprises waterborne polyurethane and water. The oil phase comprises isocyanurate, decanyl acetate and solid wax.

A homogenizer stirs the composition at 6000 rpm for 3 minutes. After the stirring process, the temperature of the composition is elevated to 45 degrees Celsius and the temperature is kept for 3 hour. Thereafter, the temperature of the composition is elevated to 65 degrees Celsius and the temperature is kept for 2 hour. The temperature is then elevated to 85 degrees Celsius and the temperature is kept for 1 hour. Finally, natriumdodecylsulfate 6 grams, is added to the composition. The natriumdodecylsulfate is a stabilizer and a aqueous solution with 38% solid contained is obtained, in which the particle size of the microcapsules are between about 1.5 micrometer and 2.5 micrometer and the phase change temperature is about at −13 degrees Celsius.

The examples disclosed above illuminate that using the composition for fabricating phase-change-material microcapsules and the method for fabricating the microcapsules provided in the present invention can fabricate hydrophilic microcapsules, in which the phase-change-material comprising carboxylic ester with formate, acetate and propionate enclosed by shell made of waterborne polyurethane and the carbon atom number of an alkoxyl of the carboxylic ester is between 10 and 18. The organic solvent is not necessary because the polar phase-change-material can solve the lipophilic monomer and the hydrophilic monomer or pre-polymer has the function of the surfactant, the surfactant is excluded from the composition of the present invention. The microcapsules produced by the composition and method provided in the present invention has hydrophilic shell, therefore, the microcapsule is dispersed in the water phase and the heating process, which damages the microcapsules for removing the solvent is avoided.

Two examples disclosed below is that the organic solvent is added to the composition of the present invention. The examples illuminate that the microcapsules can be fabricated while the composition includes organic solvent and the hydrophilic monomer or pre-polymer still can be used as a surfactant. The outstanding potency of the waterborne polyurethane is more obvious.

### EXAMPLE 8

A composition with waterborne polyurethane 48 grams, water 300 grams, isocyanurate of 1,6-hexamethylene diisocyanate 7 grams, ethyl acetate 120 grams, octadecanyl formate 217 grams and solid wax 17 grams is put in a reactor, in which a water phase comprises waterborne polyurethane and water. The oil phase comprises isocyanurate, ethyl acetate, octadecanyl formate and solid wax.

A homogenizer stirs the composition at 7000 rpm for 3 minutes. After the stirring process, the temperature of the composition is elevated to 40 degrees Celsius and the temperature is kept for 3 hour. Thereafter, the temperature of the composition is elevated to 60 degrees Celsius and the temperature is kept is for 2 hour. The temperature is then elevated to 80 degrees Celsius and the temperature is kept for 1 hour. Finally, natriumdodecylsulfate 2.6 grams, is added to the composition. The natriumdodecylsulfate is a stabilizer and a aqueous solution with 20% solid contained is obtained, in which the particle size of the microcapsules are between about 1 micrometer and 2 micrometer and the phase change temperature is about at 37 degrees Celsius.

### EXAMPLE 9

A composition with waterborne polyurethane 143 grams, water 300 grams, isocyanurate of 1,6-hexamethylene diisocyanate 21 grams, ethyl acetate 120 grams, octadecanyl acetate 169 grams and solid wax 13 grams is put in a reactor, in which a water phase comprises waterborne polyurethane and water. The oil phase comprises isocyanurate, ethyl acetate, octadecanyl acetate and solid wax.

A homogenizer stirs the composition at 6500 rpm for 3 minutes. After the stirring process, the temperature of the composition is elevated to 60 degrees Celsius and the temperature is kept for 3 hour. Thereafter, the temperature of the composition is elevated to 80 degrees Celsius and the temperature is kept for 3 hour. Finally, natriumdodecylsulfate 5 grams, is added to the composition. The natriumdodecylsulfate is a stabilizer and a aqueous solution with 25% solid contained id obtained, in which the particle size of the microcapsules are between about 1.5 micrometer and 2.5 micrometer and the phase change temperature is about at 30 degrees Celsius.

Although the present invention has been described in considerable detail with reference to certain preferred embodiments thereof, other embodiments are possible. For example, any material used to form a hydrophilic shell of the microcapsule and using any polar organic compound as phase-change-material solving the lipophilic monomer to exclude using the organic solvent. Therefore, their spirit and scope of the appended claims should no be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A composition for fabricating phase-change-material microcapsule, comprising:
5% to 40% weight percentage concentration of waterborne polyurethane aqueous solution;
phase-change-material;
lipophilic monomer; and
solid wax, wherein the weight percentage concentration of the lipophilic monomer solving in the phase change material is between about 3% and 12%, and the weight ratio of lipophilic monomer to waterborne polyurethane is between about 25% and 50%.

2. The composition of claim 1, wherein the waterborne polyurethane in the waterborne polyurethane aqueous solution is selected from a group consisting waterborne polyurethane, 2,2-bis (hydroxymethyl) propionic acid triethylamine salt, diamine containing sulfonate salt and a combination thereof.

3. The composition of claim 1, wherein the phase-change-material is an organic compound with polarity.

4. The composition of claim 1, wherein the phase-change-material is a carboxylic ester.

5. The composition of claim 4, wherein a carboxylate of the carboxylic ester is selected from a group of formate, acetate and propionate.

6. The composition of claim 4, wherein carbon atom number of an alkoxyl of the carboxylic ester are between 10 and 18.

7. The composition of claim 1, wherein the lipophilic monomer is melamine or isocyanate salt.

8. The composition of claim 1, wherein the preferred weight ratio of waterborne polyurethane to microcapsule composition is between about 10% and 30%.

9. The composition of claim 1, wherein the preferred weight percentage concentration of the lipophilic monomer solving in the phase change material is between about 5% and 10%.

10. The composition of claim 1, wherein the preferred weight ratio of lipophilic monomer to waterborne polyurethane is between about 30% and 45%.

11. A method using the composition of claim 1 for fabricating phase-change-material microcapsule dispersing in a water phase, comprising:
putting the composition in a reactor, wherein the composition comprising:
the waterborne polyurethane aqueous solution;
the phase-change-material;
the lipophilic monomer; and
the solid wax;
emulsify the composition by stirring;
performing at least two stages heating process to elevate a temperature of the emulsified composition; and
adding at least one stabilizer.

12. The method of claim 11, wherein a speed of the emulsify by stirring is between about 4000 rpm and 9000 rpm.

13. The method of claim 11, wherein a time for the emulsion by stirring is between about 2 minutes and 5 minutes.

14. The method of claim 11, wherein the temperature range is between about 20 degree Celsius and 90 degree Celsius.

15. The method of claim 11, wherein the elevating temperature further comprising:
keeping a constant temperature at each stage, wherein the duration is from 1 hour to 5 hours at the stage.

16. The method of claim 11, wherein the waterborne polyurethane in the waterborne polyurethane aqueous solution is selected from a group consisting of waterborne polyurethane, 2,2-bis (hydroxymethyl) propionic acid and its triethylamine salt, diamine containing sulfonate salt and a combination thereof.

17. The method of claim 11, wherein the stabilizer is sorbitan monooleate or sodium dodecyl sulfonate.

18. The method of claim 11, wherein the phase-change-material is an organic compound with polarity.

19. The method of claim 11, wherein the phase-change-material is a carboxylic ester.

20. The method of claim 19, wherein a carboxylate of the carboxylic ester is selected from a group consisting of formate, acetate and propionate.

21. The method of claim 19, wherein carbon atom number of an alkoxyl of the carboxylic ester is between 10 and 18.

22. A phase-change-material for fabricating a microcapsule used between minus 20 degree Celsius and 80 degree Celsius, comprising:
a carboxylic ester, wherein a carboxylate of the carboxylic ester is selected from a group formate, acetate and propionate and carbon atom number of an alkoxyl of the carboxylic ester are between 10 and 28.

23. The phase-change-material of claim 21, wherein carbon atom number of an alkoxyl of the carboxylic ester is preferred between 10 and 18.

24. The phase-change-material of claim 21, wherein the microcapsule is preferred used between minus 20 degree Celsius and 80 degree Celsius.
